(19) United States
(12) Patent Application Publication
(10) Pub. No.: US 2026/0021331 A1
(43) Pub. Date: Jan. 22, 2026

(54) FALL PROTECTION ANCHOR

(71) Applicant: WERNER CO., ITASCA, IL (US)

(72) Inventors: Karl Guthrie, Austin, TX (US); Ivan A. J. Kekahuna, Austin, TX (US); Eric S. Patrick, Manor, TX (US); Daniel Aleksovski, Signal Mountain, TN (US)

(73) Assignee: WERNER CO., ITASCA, IL (US)

(21) Appl. No.: 19/273,663

(22) Filed: Jul. 18, 2025

Related U.S. Application Data
(60) Provisional application No. 63/673,297, filed on Jul. 19, 2024.

(51) Int. Cl. A62B 35/00

(52) U.S. Cl. CPC A62B 35/0068

(57) ABSTRACT

A fall protection anchor includes a housing including a slot structured to receive a planar member, a first cam lobe coupled to the housing and having a first cam lobe surface, wherein rotation of the first cam lobe in a first direction causes the first cam lobe surface to extend further into the slot, and a first cam lobe spring coupled to the first cam lobe and structured to bias the first cam lobe in the first direction.

### CROSS REFERENCE TO RELATED APPLICATIONS

This application claims priority to U.S. Provisional Patent Application Ser. No. 63/673,297, filed on Jul. 19, 2024, and titled “FALL PROTECTION ANCHOR” the disclosure of which is incorporated herein by reference.

### FIELD OF THE INVENTION

The disclosed concept relates generally to anchors, and more particularly to anchors for fall protection systems.

### BACKGROUND OF THE INVENTION

Fall protection systems typically require anchor points attached to a structure. A user may then attach a lanyard to the anchor point. However, anchor points often require drilling into the structure to securely attach an anchoring device to the structure, or modifying the structure in some manner to accommodate attachment of an anchoring device or to create an anchor point from the structure. Drilling into or modifying the structure can be detrimental to the structure.

One type of structure is an I-beam. I-beams have exposed steel flanges. In many types of I-beams the flange of the I-beam has parallel surfaces. It can be detrimental to drill into or modify the flange of an I-beam. However, I-beams are often disposed in locations that would serve well for anchor points for fall protection systems. It is a challenge to create an anchor point with sufficient strength for use in fall protection applications without drilling into or otherwise modifying the structure it is attached to.

### SUMMARY OF THE INVENTION

In accordance with an example embodiment of the disclosed concept, a fall protection anchor comprises: a housing including a slot structured to receive a planar member; a first cam lobe coupled to the housing and having a first cam lobe surface, wherein rotation of the first cam lobe in a first direction causes the first cam lobe surface to extend further into the slot; and a first cam lobe spring coupled to the first cam lobe and structured to bias the first cam lobe in the first direction.

In accordance with an example embodiment of the disclosed concept, a fall protection anchor comprises: a housing including a slot structured to receive a planar member, and an angled surface cavity having an angled surface; a roller cam disposed within the angled surface cavity and structured to move along the angled surface, wherein the roller cam includes a roller cam surface and movement of the roller cam along the angled surface in a first direction causes the roller cam surface to extend further into the slot; and a roller cam spring coupled to the roller cam and structured to bias the roller cam in the first direction.

In accordance with an example embodiment of the disclosed concept, a fall protection anchor comprises: a housing including a slot structured to receive a planar member; a cam member coupled to the housing and structured to move into the slot into a gripping position to grip the planar member between the cam member and a surface opposite the cam member; a bias member coupled to the cam member and structured toward the gripping position; and a release mechanism coupled to the cam member and operable to move the cam member away from the gripping position.

In accordance with an example embodiment of the disclosed concept, a fall protection anchor comprises: a housing including a slot structured to receive a planar member; a cam member coupled to the housing and structured to move into the slot into a gripping position to grip the planar member between the cam member and a surface opposite the cam member; a bias member coupled to the cam member and structured to bias the cam member toward the gripping position; a preload mechanism operable to move the cam member to a position away from the gripping position; and a trigger mechanism structured to retain the cam member in the position away from the gripping position, and wherein the trigger mechanism is structured to release the cam member and allow the bias member to rotate the cam member to the gripping position in response to the planar member being received in the slot.

### BRIEF DESCRIPTION OF THE DRAWINGS

A full understanding of the invention can be gained from the following description of the preferred embodiments when read in conjunction with the accompanying drawings in which:

FIG. 1 is an isometric view of a fall protection anchor in accordance with an example embodiment of the disclosed concept;

FIG. 2 is a side view of the fall protection anchor of FIG. 1 with internal elements of the fall protection anchor shown;

FIG. 3 is a side view of the fall protection anchor of FIG. 1 with internal elements of the fall protection anchor shown and with the fall protection anchor in use with an I-beam;

FIG. 4 is an isometric view of the fall protection anchor of FIG. 1 with internal elements shown;

FIG. 5 is a view of a fall protection anchor in accordance with another example embodiment of the disclosed concept;

FIG. 6 is a cross-sectional view of the fall protection anchor of FIG. 5;

FIG. 7 is a cross-sectional view of the fall protection anchor of FIG. 5 in use with an I-beam;

FIG. 8 is a cross-sectional view of a fall protection anchor in accordance with another example embodiment of the disclosed concept;

FIG. 9 is a side view of the fall protection anchor of FIG. 8;

FIG. 10 is an isometric view of the fall protection anchor of FIG. 8;

FIG. 11 is an isometric view of a fall protection anchor in accordance with an example embodiment of the disclosed concept

FIG. 12 is a cross-sectional view of the fall protection anchor of FIG. 11;

FIG. 13 is another isometric view of the fall protection anchor of FIG. 11;

FIG. 14 is a side view of the fall protection anchor of FIG. 11;

FIG. 15 is an isometric view of a fall protection anchor in accordance with another example embodiment of the disclosed concept;

FIG. 16 is a cross-sectional view of the fall protection anchor of FIG. 15;

FIG. 17 is a cross-sectional view of a fall protection anchor in accordance with another example embodiment of the disclosed concept;

FIG. 18 is a side view of a fall protection anchor in a resting position in accordance with an example embodiment of the disclosed concept;

FIG. 19 is a side view of the fall protection anchor of FIG. 18 in a prepped position in accordance with an example embodiment of the disclosed concept;

FIG. 20 is a side view of the fall protection anchor of FIG. 18 in a pre-mount position in accordance with an example embodiment of the disclosed concept;

FIG. 21 is a side view of the fall protection anchor of FIG. 18 in a mounted position in accordance with an example embodiment of the disclosed concept;

FIG. 22 is a side view of the fall protection anchor of FIG. 18 in a fully mounted position in accordance with an example embodiment of the disclosed concept;

FIG. 23 is a side view of the fall protection anchor of FIG. 18 returned to a prepped position in accordance with an example embodiment of the disclosed concept;

FIGS. 24 and 25 are side views of the fall protection anchor of FIG. 18 with an outer housing and cam lobe hidden;

FIGS. 26 and 27 are side views of the fall protection anchor of FIG. 18 with an outer housing hidden; and

FIG. 28 is a side view of a fall protection anchor with a set screw in accordance with an example embodiment of the disclosed concept.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “coupled” together shall mean that the parts are joined together either directly or joined through one or more intermediate parts.

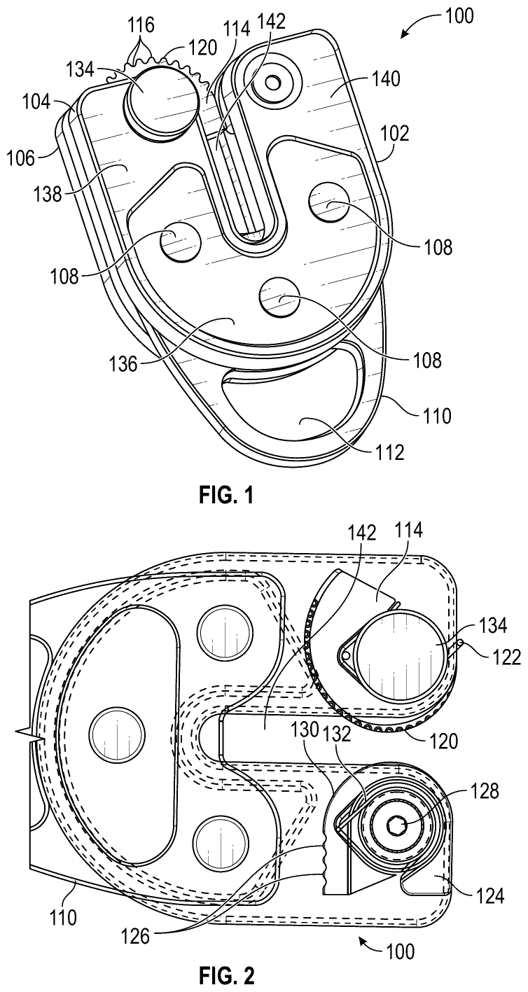

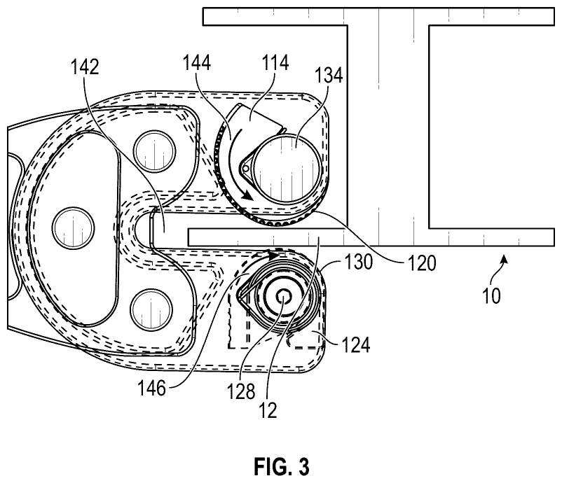

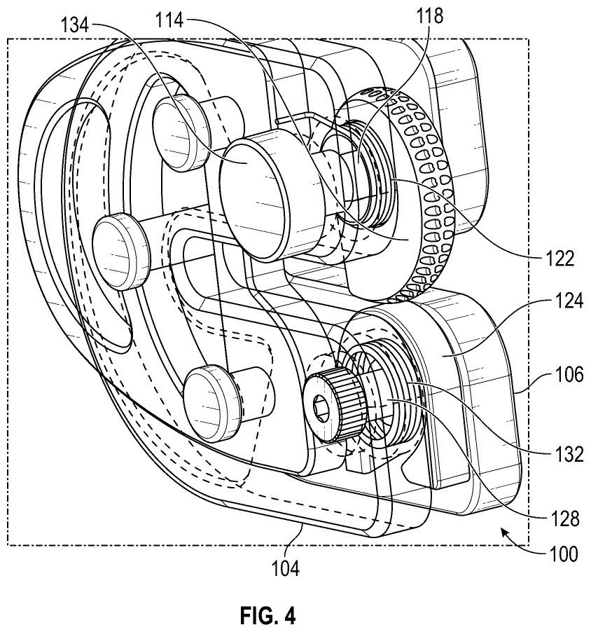

FIG. 1 is an isometric view of a fall protection anchor 100 in accordance with an example embodiment of the disclosed concept. FIG. 2 is a side view of the fall protection anchor 100 of FIG. 1 with internal elements of the fall protection anchor shown. FIG. 3 is a side view of the fall protection anchor 100 of FIG. 1 with internal elements of the fall protection anchor 100 shown and with the fall protection anchor 100 in use with an I-beam 10. FIG. 4 is an isometric view of the fall protection anchor 100 of FIG. 1 with internal elements shown.

The fall protection anchor 100 is suitable for attaching to a planar member such as a flange 12 of an I-beam 10, as shown for example in FIG. 3. As used herein, a planar member means a planar object that includes at least two substantially parallel opposite surfaces. It will be appreciated that the fall protection anchor 100 is suitable for attaching to other planar members that include parallel opposite surfaces similar to a flange. The fall protection anchor 100 includes an attachment ring 110 with an attachment ring opening 112. The attachment ring 110 and attachment ring opening 112 are suitable as an attachment point for a fall protection lanyard (e.g., without limitation, a snap hook or a similar device). A fall protection lanyard may be coupled to a safety harness of a worker, and the fall protection anchor 100 may serve as an anchor point when attached to the I-beam 10 or another structure. That is, in the case of a worker fall, the fall protection anchor 100 will remain attached to the I-beam 10 or other structure despite the forces applied to the fall protection anchor 100 due to the fall of the worker.

In the example embodiment shown in FIGS. 1-4, the fall protection anchor 100 includes a housing 102. The housing 102 includes a housing first part 104 and a housing second part 106. The housing first part 104 and the housing second part 106 are curved planar pieces that have a substantially C-shape or U-shape. The housing first part 104 and the housing second part 106 may be composed of a metallic material, such as, for example and without limitation, steel, in some example embodiments. The housing first part 104 and the housing second part 106 are coupled together by a number of fasteners 108. In the example embodiment shown in FIGS. 1-4, the number of fasteners 108 is three. However, it will be appreciated that other numbers of fasteners 108 may be employed.

The housing first part 104 and the housing second part 106 each include a housing curved portion 136, a housing first extended portion 138, and a housing second extended portion 140. The housing first extended portion 138 and the housing second extended portion 140 are each substantially rectangular planar portions extending substantially in parallel with each other. The housing curved portion 136 is a planar curved portion that joins the housing first extended portion 138 and the housing second extended portion 140. It will be appreciated that the housing first part 104 and the housing second part 106 may each be monolithic unitary pieces. A slot 142 is formed between the housing first extended portion 138, the housing second extended portion 140, and the housing curved portion 136. The slot 142 is suitable to receive the flange 12 of the I-beam 10, or other planar member with parallel surfaces.

The fall protection anchor 100 includes the attachment ring 110. The attachment ring 110 is a planar piece that includes an attachment ring opening 112. A portion of the attachment ring 110 is disposed between the housing first part 104 and the housing second part 106. One or more of the fasteners 108 pass through the attachment ring 110 and couple the attachment ring 110 to the housing first part 104 and the housing second part 106. The portion of the attachment ring 110 disposed between the housing first part 104 and the housing second part 106 does not include the attachment ring opening 112. The attachment ring opening 112 is accessible and suitable for a worker to connect a fall protection lanyard to it.

The fall protection anchor 100 further includes a first cam lobe 114 and a second cam lobe 124. The first cam lobe 124 is disposed proximate a distal end of the housing first extended portion 138. The distal end of the housing first extended portion 138 is an end of housing first extended portion 138 furthest from the housing curved portion 136. The first cam lobe 114 is rotatable about a first cam lobe axis 118. The first cam lobe 114 includes a first cam lobe outer surface 120. The distance from the first cam lobe axis 118 to the first cam lobe surface 120 varies along the length of the first cam lobe surface 120. In some example embodiments, the distance from the first cam lobe axis 118 to the first cam lobe surface 120 increases along the length of the first cam lobe surface 120. In some example embodiments, the first cam lobe surface 120 may include first cam lobe teeth 116. The first cam lobe teeth 116 are not limited to the structures shown in FIGS. 1-4. The first cam lobe teeth 116 may be, for example and without limitation, indents, protrusions, ridges, or any other structure which increases the ability of the first cam lobe surface 120 to grip another surface.

The second cam lobe 124 is disposed proximate a distal end of the housing second extended portion 140. The second cam lobe 124 is rotatable about a second cam lobe axis 128. The second cam lobe 124 includes a second cam lobe outer surface 130. The distance from the second cam lobe axis 128 to the second cam lobe surface 130 varies along the length of the second cam lobe surface 130. In some example embodiments, the distance from the second cam lobe axis 128 to the second cam lobe surface 130 increases along the length of the second cam lobe surface 130. In some example embodiments, the second cam lobe surface 130 includes a curved portion and one or more straight portions. In some example embodiments, the second cam lobe surface 130 may include second cam lobe teeth 126. The second cam lobe teeth 126 are not limited to the structures shown in FIGS. 1-4. The second cam lobe teeth 126 may be, for example and without limitation, indents, protrusions, ridges, or any other structure which increases the ability of the first cam lobe surface 120 to grip another surface.

The first cam lobe 114 and the second cam lobe 124 are disposed on opposite sides of the slot 142 and are structured to variably extend into the slot 142. For example, as the first cam lobe 114 rotates in one direction, the first cam lobe surface 120 extends further into the slot 142, and when the first cam lobe 114 rotates in the opposite direction, the distance the first cam lobe surface 120 extends into the slot 142 decreases. For example, as the first cam lobe 114 rotates in the counterclockwise direction 144 shown in FIG. 3, the first cam lobe surface 120 extends further into the slot 142. In this example embodiment, the distance between the first cam lobe axis 118 and the first cam lobe surface 120 increases in a clockwise direction along the length of the first cam lobe surface 120. Thus, rotating the first cam lobe 114 in the counterclockwise direction 144 causes the first cam lobe surface 120 to extend further into the slot 142 as the first cam lobe 114 is rotated. Rotating the first cam lobe 114 in the clockwise direction 144 causes the first cam lobe surface 120 to extend less into the slot 142 as the first cam lobe 114 is rotated.

Rotating the second cam lobe 124 in the clockwise direction 146, as shown in FIG. 3, causes the second cam lobe surface 130 to extend further into the slot 142, and rotating the second cam lobe 124 in the counterclockwise direction causes the second cam lobe surface 130 to extend less into the slot 142. The first cam lobe 114 and the second cam lobe 124 are arranged such that inserting an object into the slot 142, such as the flange 12 of the I-beam 10, will cause the first cam lobe 114 and the second cam lobe 124 to rotate in directions that cause the first cam lobe surface 120 and the second cam lobe surface 130 to extend less into the slot 142, and attempting to remove an object from the slot 142 will cause the first cam lobe 114 and the second cam lobe 124 to rotate in directions that cause the first cam lobe surface 120 and the second cam lobe surface 130 to extend further into the slot 142. Inserting an object into the slot 142 will cause the object to be gripped between the first cam lobe surface 120 and the second cam lobe surface 130. Attempting to pull the object out of the slot 142 will cause the first cam lobe 114 and the second cam lobe 124 to rotate and the first cam lobe surface 120 and the second cam lobe surface 130 to extend further into the slot 142 and increase the gripping force on the object in the slot 142. In some example embodiments, the first cam lobe 114 is structured to provide a mechanical advantage of at least four times the force pulling the object out of the slot 142. That is, the as a force pulls the object out of the slot 142, the cam lobe 114 rotates and increases the gripping force on the object between the first cam lobe 114 and the second cam lobe 124. For example, if the force pulling the object out of the slot 142 is 10 lbs, the first cam lobe 114 will provide a gripping force of at least 40 lbs. If the force pulling the object out of the slot 142 increases to 100 lbs, the first cam lobe 114 further rotates and increases the gripping force to at least 400 lbs. In some example embodiments, the mechanical advantage provided by the first cam lobe 114 may be a different amount (e.g., without limitation 2, 6, 8, 10, etc.). In the case of the flange 12 of the I-beam 10, the flange 12 may be inserted into the slot 142 and be gripped between the first cam lobe surface 120 and the second cam lobe surface 130. When the fall protection anchor 100 is used as an anchor point in a fall protection system, a fall would cause the fall protection anchor 100 to pull away from the flange 12 and pull the flange 12 out of the slot 142. However, the forces attempting to pull the flange 12 out of the slot 142 would also cause the first cam lobe 114 and second cam lobe 124 to rotate and the first cam lobe surface 120 and the second cam lobe surface 130 to further extend into the slot 142 and tighten the grip on the flange 12. Thus, the fall protection anchor 100 would tighten its grip on the flange 12 in the case of a fall and remain attached to the flange 12.

The first cam lobe teeth 116 and the second cam lobe teeth 126 respectively enhance the ability of the first cam lobe surface 120 and the second cam lobe surface 130 to grip the flange 12 or other object disposed in the slot 142. It will be appreciated that the first cam lobe teeth 116 and the second cam lobe teeth 126 may be omitted in some example embodiments.

While cam lobes are described with respect to the fall protection anchor 100, it will be appreciated that other types of cam members may be employed without departing from the scope of the disclosed concept. Roller cams, ball cams, and angled cams are described herein as alternative cam members, but it will be appreciated that any cam member may be employed without departing from the scope of the disclosed concept.

The fall protection anchor 100 further includes a first cam lobe spring 122 and a second cam lobe spring 132. The first cam lobe spring 122 is coupled to the first cam lobe 114 and is structured to bias the first cam lobe 114 to rotate in the counterclockwise direction 144 (i.e., the rotational direction which causes the first cam lobe surface 120 to further extend into the slot 142 to a gripping position). The second cam lobe spring 146 is structured to bias the second cam lobe 124 in a rotational direction which causes the second cam lobe surface 130 to extend less into the slot 142 (i.e., a counterclockwise direction). When the flange 12 is inserted into the slot 142, the flange 12 overcomes the bias of the first cam lobe spring 122 and causes the first cam lobe 114 to rotate in a rotational direction which causes the first cam lobe surface 120 to extend less into the slot 142 and accommodate the flange 12 in the slot 142. Once the flange 12 has been inserted into to the slot 142, the bias of the first cam lobe spring 122 causes the first cam lobe 114 to rotate in the counterclockwise direction, moving the first cam lobe surface 120 further into the slot 142 and applying a gripping force against the flange 12, thus securing the flange 12 between the first cam lobe surface 120 and the second cam lobe surface 130. If the flange 12 is attempted to be removed from the slot 142 (e.g., without limitation, in the event of a fall), as the flange 12 is attempted to be pulled out of the slot 142, the frictional force between the flange 12 and the first cam lobe surface 120 causes the first cam lobe 114 to rotate in the counterclockwise direction and cause the first cam lobe surface 120 to further extend into the slot 142 and increase the gripping force on the flange 12. The frictional force between the flange 12 and the second cam lobe surface 130 causes the second cam lobe 124 to rotate in the clockwise direction, overcoming the bias of the second cam lobe spring 132 and causing the second cam lobe surface 130 to further extend into the slot 142 and increase the gripping force on the flange 12. As the flange 12 is pulled out of the slot 142, the gripping force of the first cam lobe 114 and the second cam lobe 124 on the flange 12 continually increases until the gripping force is greater than the force pulling the flange 12 out of the slot 142 and the flange 12 cannot be pulled any further out of the slot 142. In example embodiments, the gripping force of the first cam lobe 114 and the second cam lobe 124 on the flange 12 increases sufficiently to overcome the forces of a fall before the flange 12 can be pulled out of the slot 142. That is, in the event of a fall, the flange 12 will be retained in the slot 142 and the fall protection anchor 100 will remain attached to the flange 12 and the I-beam 100.

The fall protection anchor 100 further includes a retraction mechanism 134. The retraction mechanism 132 is structured to allow the fall protection anchor 100 to release the flange 12 so that the flange 12 can be removed from the slot 142. In some example embodiments, the retraction mechanism 134 is a knob coupled to the first cam lobe axis 118 that allows a user to manually manipulate the knob to rotate the first cam lobe 114. For example, a user may manually manipulate the knob to rotate the first cam lobe 114 in a clockwise direction to overcome the bias of the first cam lobe spring 122 and cause the first cam lobe surface 120 to extend less into the slot 142. After sufficient rotation, the first cam lobe surface 120 is retracted enough that it no longer grips the flange 12 and the flange 12 is able to be removed from the slot 142. In some example embodiments, the retraction mechanism 134 may require at least two actions to allow a user to retract the first cam lobe 114. For example and without limitation, in some example embodiments, the user may need to perform a first action, such as pulling out the knob before performing a second action of rotating the knob in order to retract the first cam lobe 114.

In some example embodiments, the fall protection anchor 100 is structured to sustain its grip on a flange 12 or other planar member gripped by the first cam lobe 114 in response to at least 1800 lbs of force applied to the attachment ring 110. In some example embodiments, the fall protection anchor 100 is structured to sustain its grip on the flange 12 or other planar member in response to at least a lesser force (e.g., without limitation 1000, 1200, 1400, 1600 lbs, etc.) applied to the attachment ring 110. In some example embodiments, the fall protection anchor 100 is structured to sustain its grip on the flange 12 or other planar member in response to at least a greater force (e.g., without limitation 2000, 2200, 2400, 2600 lbs, etc.) applied to the attachment ring 110.

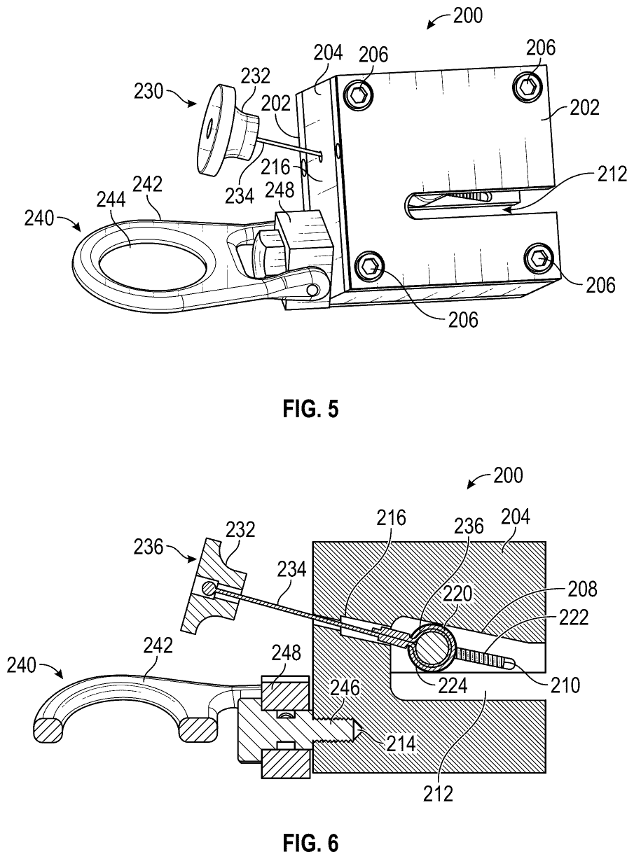

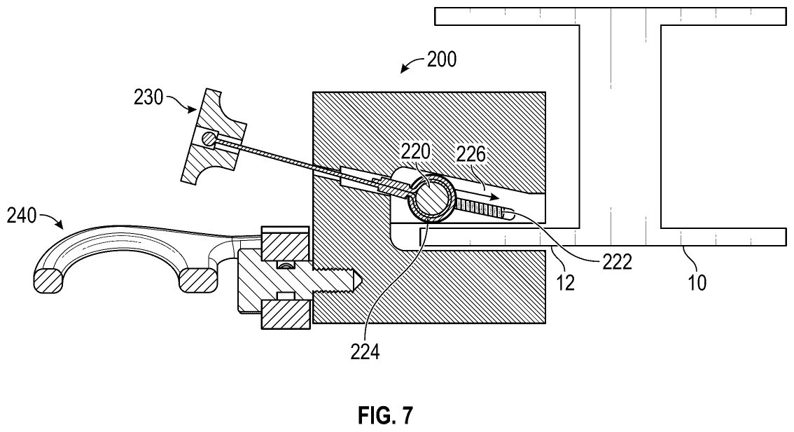

FIG. 5 is a view of a fall protection anchor 200 in accordance with another example embodiment of the disclosed concept. FIG. 6 is a cross-sectional view of the fall protection anchor 200 of FIG. 5. FIG. 7 is a cross-sectional view of the fall protection anchor 200 of FIG. 5 in use with an I-beam 10.

The fall protection anchor 200 is suitable for attaching to planar member such as a flange 12 of an I-beam 10, as shown for example in FIG. 7. It will be appreciated that the fall protection anchor 200 is suitable for attaching to other structures that include parallel opposite surfaces similar to a flange. The fall protection anchor 200 includes an attachment mechanism 240 with an attachment ring 242 with an attachment ring opening 244. The attachment ring 242 and attachment ring opening 244 are suitable as an attachment point for a fall protection lanyard. A fall protection lanyard may be coupled to a safety harness of a worker, and the fall protection anchor 200 may serve as an anchor point when attached to the I-beam 10 or another structure. That is, in the case of a worker fall, the fall protection anchor 200 will remain attached to the I-beam 10 or other structure despite the forces applied to the fall protection anchor 200 due to the fall of the worker.

The fall protection anchor 200 includes a housing 200. In some example embodiments, the housing 200 includes a housing body 204 and housing covers 202. The housing covers 202 are disposed on opposite sides of the housing body 204. One or more fasteners 206 are structured to couple the housing covers 202 to the housing body 204.

A slot 212 is formed in the housing 200. The slot 212 extends through the housing covers 202 and the housing body 204. The slot 212 is suitable for insertion of a structure having parallel surfaces, such as the flange 12 of the I-beam 10. The flange 12 inserted into the slot 212 is shown in FIG. 7, for example.

The housing body 204 includes an angled surface cavity 208 formed in the housing body 204 adjacent to the slot 212. The angled surface cavity 208 has an angled surface that slopes such that at a near end of the angled surface cavity 208, the angled surface is closer to the slot 212 than at a distal end of the angled surface cavity 208. The near end of the angled surface cavity 208 is the end of the angled surface cavity 208 adjacent to an edge of the housing 200 and the opening of the slot 212. The distal end of the angled surface cavity 208 is the end of the surface cavity 208 furthest into the housing body 204.

The fall protection anchor 200 includes a roller cam 220. The roller cam 220 is disposed in the angled surface cavity 208 and is structured to extend a variable distance into the slot 212. The roller cam 220 includes a roller cam surface 222 that is structured to grip the flange 12 between the roller cam surface 222 and an opposite side of the slot 212, as is shown for example in FIG. 7. The roller cam 220 is structured to roll along the angled surface of the angled surface cavity 208. As the roller cam 220 rolls toward the near end of the angled surface cavity 208 (i.e., the end adjacent the opening of the slot 212), the roller cam surface 222 extends further into the slot 212, thus increasing the gripping force on the flange 12.

The housing covers 202 each include a spring slot 210. The spring slots 210 are angled at a similar angle as the angled surface of the angled surface cavity 208. The spring slots 210 are structured to accommodate roller cam springs 222. The roller cam springs 222 are structured to bias the roller cam 220 in a direction toward the near end of the angled surface cavity 208, for example in bias direction 226 shown in FIG. 7. When the flange 12 is inserted into the slot 212, the flange 12 overcomes the bias of roller cam springs 222 and pushes the roller cam 220 toward the distal end of the angled surface cavity 208, which causes the roller cam surface 224 to retract from the slot 212 and provide space for the flange 12 to be inserted into the slot 212. Once the flange 12 has been inserted into the slot 212, the roller cam springs 222 bias the roller cam 220 toward the near end of the angled surface cavity 208, which causes the roller cam 220 to move toward the near end of the angled surface cavity 208 and the roller cam surface 224 to extend further into the slot 212 and grip the flange 12 between the roller cam surface 224 and an opposite side of the slot 212. If the flange 12 is attempted to be pulled out of the slot 212, the frictional force between the flange 12 and the roller cam 220 causes the roller cam 220 to move further toward the near end of the angled surface cavity 208 and the roller cam surface 224 to extend further into the slot 212, thus increasing the gripping force on the flange 12. In this manner, as the flange 12 is attempted to be removed from the slot 212, the gripping force on the flange 12 is increased and the flange 12 cannot be removed from the slot 212. In some example embodiments, the gripping force is sufficient to hold the flange 12 in slot 212 against the forces experienced during a fall event.

The fall protection anchor 200 further includes a release mechanism 230. The release mechanism 230 includes a handle 232 and a coupling member 234. The coupling member 234 is coupled at a near end to the handle 232 and extends into the housing body 204 through a release mechanism bore 216 formed in the housing body 204. A distal end of the coupling member 234 includes a clamp frame 236 structured to couple to the roller cam 220. The release mechanism 230 is structured such that pulling on the handle 232 causes the roller cam 220 to move toward the distal end of the angled surface cavity 208, which causes the roller cam surface 224 to retract from the slot 212. To release the flange 12 from the fall protection anchor 200 so that the flange 12 can be removed from the slot 212, a user pulls on the handle 232 to overcome the bias of the roller cam springs 222 and pull the roller cam 220 toward the distal end of the angled surface cavity 208. Once the roller cam 220 moves a sufficient distance toward the distal end of the angled surface cavity 208, the roller cam surface 224 retracts from the slot 212 sufficiently that the flange 12 is no longer gripped between the roller cam surface 224 and the opposite side of the slot 212. The flange 12 can then be removed from the slot 212.

The attachment mechanism 240 includes a fastener 246 and a swivel housing 248. The swivel housing 248 is structured to couple to the attachment ring 242. The fastener 246 is structured to extend through the swivel housing 248 into a bore 214 formed in the housing body 214 and couple the attachment mechanism 240 to the housing body 204. The swivel housing 248 is structured to rotate about the fastener 246, thus allowing the attachment ring 242 to also rotate about the fastener 246. The attachment ring 242 is also rotatably coupled to the swivel housing 248, thus allowing the attachment ring 242 to rotate about the swivel housing 248. Thus, the attachment ring 242 is able to rotate in multiple directions with respect to the housing 200.

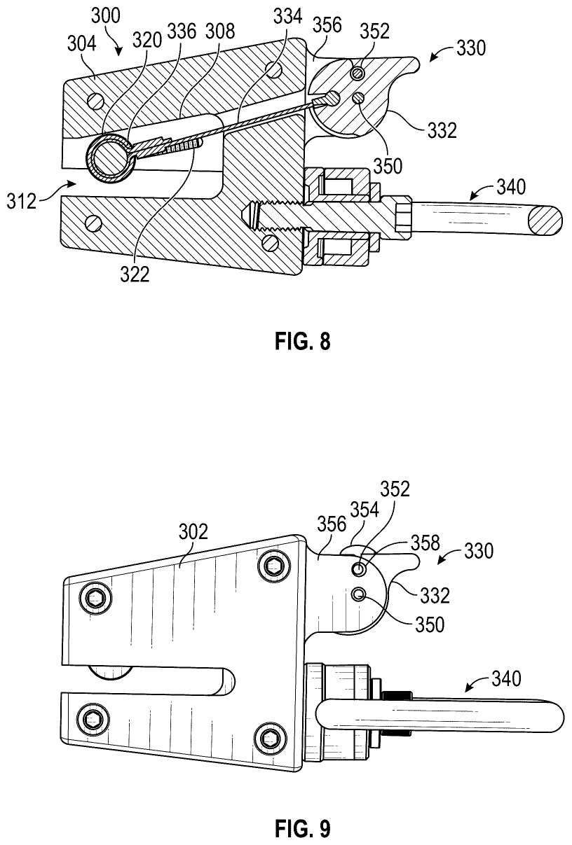

FIGS. 8-17 illustrate fall anchors in accordance with example embodiments of the disclosed concept.

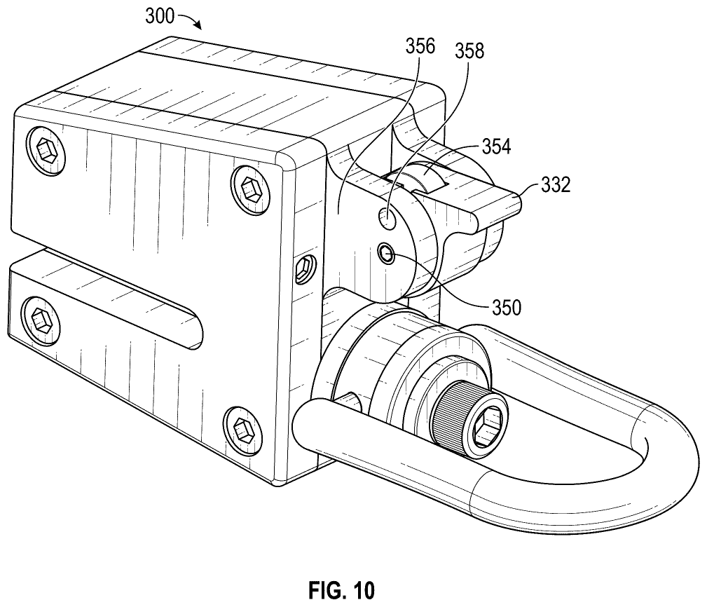

FIG. 8 is a cross-sectional view of a fall protection anchor 300 in accordance with another example embodiment of the disclosed concept. FIG. 9 is a side view of the fall protection anchor 300 of FIG. 8. FIG. 10 is an isometric view of the fall protection anchor 300 of FIG. 8. The fall protection anchor 300 is similar to the fall protection anchor 200 shown in FIGS. 5-7. However, the fall protection anchor 300 includes a release mechanism 330 that requires two actions to release. In more detail, the fall protection anchor 300 includes housing body 304 that includes an angled surface cavity 308 similar to the fall protection anchor 200. The fall protection anchor 300 includes a roller cam 320 coupled to the release mechanism 330 via a coupling member 334 and a clamp frame 336. Roller cam springs 322 bias the roller cam 320 toward the near end of the angled surface cavity 308, which causes the roller cam 320 to move toward the near end of the angled surface cavity 308 and extend further into the slot 312. The fall protection anchor 300 further includes an attachment mechanism 340 and housing covers 302 similar to the fall protection anchor 200. For economy of disclosure, description of elements of the fall protection anchor 300 that are similar to the fall protection anchor 200 are omitted.

The release mechanism 330 includes a rotatable member 332 rotatable about an axis 350 coupled to a housing protrusion 356. A release member 354 is slidably coupled to the rotatable member 332 and includes a locking pin 352. The release member 354 is structured to slide between a first position in which the locking pin 352 does not protrude into a locking hole 358 formed in the housing protrusion 356 and a second position in which the locking pin 352 protrudes into the locking hole 358 of the housing protrusion 356. In the first position, the rotatable member 332 is able to rotate about the axis 350 in response to manipulation by a user. In the second position, the locking pin 352 interacts with the locking hole 358 and prevents the rotatable member 332 from being rotated about the axis 350. Rotation of the rotatable member 332 in one direction pulls the coupling member 334 and causes the roller cam 320 to retract from the slot 312, thus enabling the fall protection anchor 300 to release from an I-beam or other planar member that it is attached to. Thus, when the release mechanism 330 is in the second position, two action must be taken to release the fall protection anchor 300 from an I-beam or other planar member. The first action is to slide the release member 354 to the first position, thus moving the locking pin 352 out of the locking hole 350. The second action is to rotate the rotatable member 332 to pull the roller cam 320 against the bias of the roller cam springs 322 to pull the roller cam 320 along the angled surface cavity 308 and cause the roller cam 320 to retract from the slot 312. It will be appreciated that the release mechanism 330 may further include a bias member structured to bias the release member 354 to the second position. Further, it will be appreciated that the positions of the locking pin 352 and locking hole 350 may correspond to a position where the roller cam 320 is sufficiently extended into the slot 312 to attach to an I-beam or planar member. Release mechanisms requiring two actions to release improve safety by avoiding a user inadvertently activating the release mechanism and causing the fall protection anchor to release. It will be appreciated that release mechanisms requiring two actions to release may be incorporated into any embodiment.

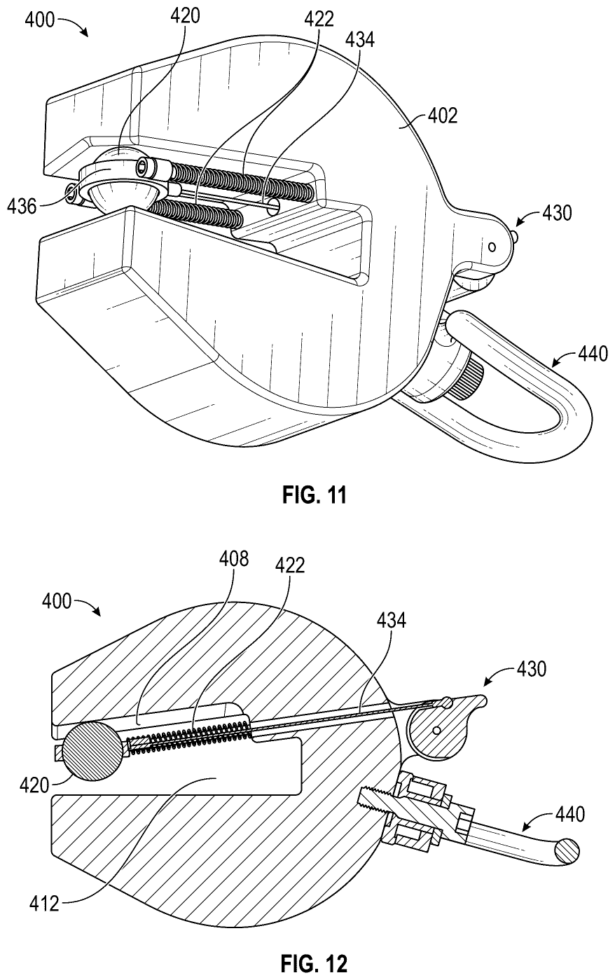

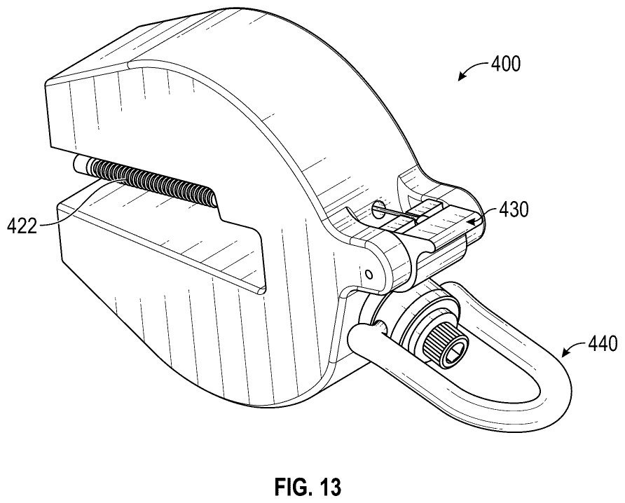

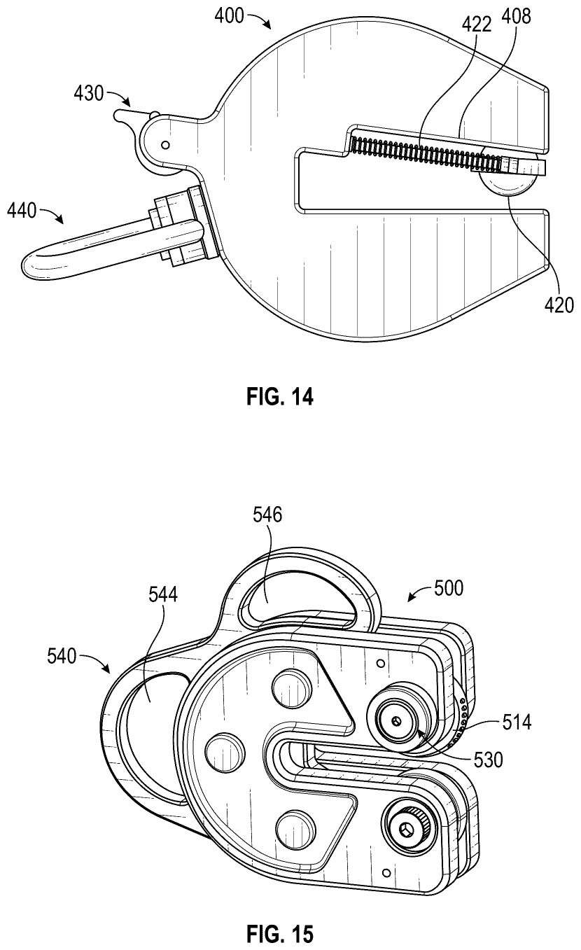

FIG. 11 is an isometric view of a fall protection anchor 400 in accordance with an example embodiment of the disclosed concept. FIG. 12 is a cross-sectional view of the fall protection anchor 400 of FIG. 11. FIG. 13 is another isometric view of the fall protection anchor 400 of FIG. 11. FIG. 14 is a side view of the fall protection anchor 400 of FIG. 11.

The fall protection anchor 400 is similar to the fall protection anchor 200 of FIGS. 5-7. However, the fall protection anchor 400 includes a ball cam 420 rather than a roller cam 220. It will be appreciated that the disclosed concept contemplates that any suitable type of cam member may be employed in the various embodiments. While a cam lobe, a roller cam, and a ball cam have been described in various embodiments, it will be appreciated that any type of cam member may be employed.

The fall protection anchor 400 includes a housing 402 forming a slot 412, a release mechanism 430, and an attachment mechanism 440. The release mechanism 430 is coupled to the roller cam 420 via a coupling member 434 and a coupling bracket 436. The housing 402 includes an angled surface cavity 408. Springs 422 bias the ball cam 436 to a near end of the angled surface cavity 408. The near end of the angled surface cavity 408 is the end of the angled surface cavity 408 adjacent to an edge of the housing 402 and the opening of the slot 412. The distal end of the angled surface cavity 408 is the end of the surface cavity 408 furthest into the housing 402. The release mechanism 430 includes a rotatable member that may be rotated to pull the ball cam 420 toward the distal end of the angled surface cavity 408 to cause the ball cam 420 to retract from the slot 412 and release any I-beam or planar member attached to the fall protection anchor 400. The release mechanism 430 may require a single action or may require two actions to release like the fall protection anchor 300.

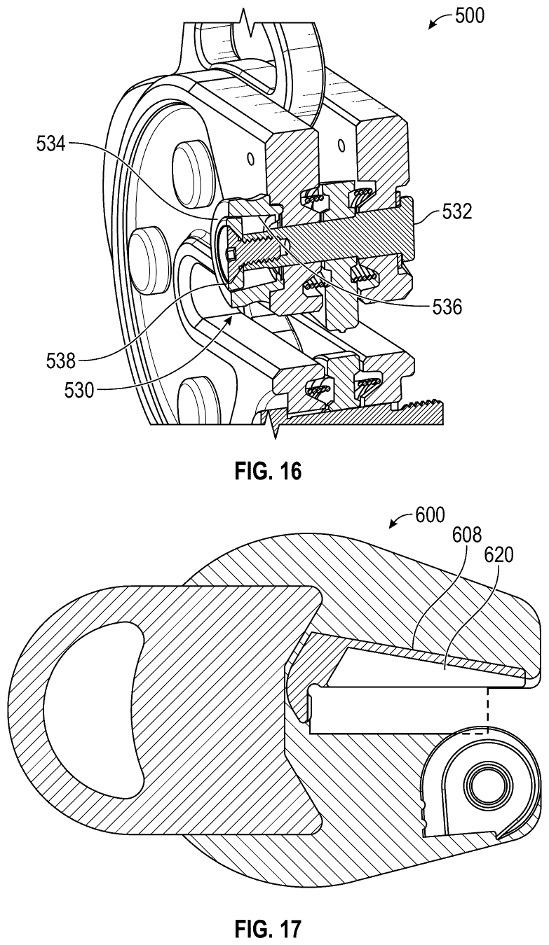

FIG. 15 is an isometric view of a fall protection anchor 500 in accordance with another example embodiment of the disclosed concept. FIG. 16 is a cross-sectional view of the fall protection anchor 500 of FIG. 15. The fall protection anchor 500 is similar to the fall protection anchor 100 of FIGS. 1-4. For economy of disclosure, repeated description of similar elements is omitted. The fall protection anchor 500 differs from the fall protection anchor 100 in that the fall protection anchor 500 includes a release mechanism 530 that requires two actions to release and an attachment mechanism 540 that includes multiple attachment points.

The release mechanism 530 includes a knob 534 that shares a shaft 532 with a cam lobe 514. The knob 534 has a hollow interior that includes angled surfaces 536. The shaft 532 extends through the hollow knob 534 and an end of the shaft 532 is coupled to an engagement member 538. The engagement member 538 has an outer perimeter that corresponds in shape to the interior of the knob 534. A diameter of the angled surfaces 536 of the knob 534 increases from an end of the knob 534 closest to the cam lobe 514 to an end of the knob 534 furthest from the cam lobe 514. The diameter of the engagement member 538 is smaller than the largest diameter of the angled surface 536 but larger than the smallest diameter of the angled surface 536. The knob 534 is structured to move axially with respect to the shaft between a first position and a second position. In the first position, the knob 534 is against the housing of the fall protection anchor 500 and the engagement member 538 is at a point where the diameter of the angled surface 536 is greater than the diameter of the engagement member 538. In the first position, if the knob 534 is rotated, the knob 534 rotates about the engagement member 538 and shaft 532, and does not affect the cam lobe 514. Pulling the knob 534 away from the housing of the fall protection anchor 500 moves the knob 534 to the second position. In the second position, the knob 534 has been pulled away from the housing of the fall protection anchor 500 sufficiently that the engagement member 538 is at a position where the diameter of the angled surface 536 is about equal to the diameter of the engagement member 538. In the second position, the engagement member 538 abuts against and engages the angled surface 536 of the knob 534, and when the knob 534 is rotated, the engagement of the engagement member 538 and the angled surface 536 of the knob 534 causes the engagement member 538, shaft 532, and cam lobe 514 to rotate in conjunction with the knob 534. In the first position, a user cannot cause rotation of the cam lobe 514 with the knob 534, but in the second position, a user can cause rotation of the cam lobe 514 with the knob 534. Thus, the fall protection anchor 500 requires two actions to release it from an I-beam or other planar member. The first action is to pull the knob 534 to move the knob 534 to the second position. The second action is to rotate the knob 534 and cause rotation of the cam lobe 514. It will be appreciated that the fall protection anchor 500 may include a bias member that biases the knob 534 to the first position. The fall protection anchor 500 is similar to the fall protection anchor 100, but the fall protection anchor 500 requires two actions to release, which improves safety and avoids an inadvertent release. It will be appreciated that the fall protection anchor 100 may also include a two-action release mechanism without departing from the scope of the disclosed concept.

The fall protection anchor 500 further includes an attachment mechanism 540 that includes multiple attachment points. The attachment mechanism 540 includes a first opening 544 disposed on one side of the fall protection anchor 500 and a second opening 546 disposed on another side of the fall protection anchor 500. Either of the first or second opening 544 or 546 may be used as an attachment point for a lanyard in a fall protection system. The multiple attachment points allow the fall protection anchor 500 to be more optimally attached to in different applications. For example, when the fall protection anchor 500 is oriented vertically, one attachment point may be optimal, while when the fall protection anchor 500 is oriented horizontally, another attachment point may be optimal. It will be appreciated that any embodiment may employ one, two, or any number of attachment points. It will also be appreciated that any embodiment may employ a swivel attachment point such as is shown in the fall protection anchor 200.

FIG. 17 is a cross-sectional view of a fall protection anchor 600 in accordance with another example embodiment of the disclosed concept. The fall protection anchor 600 is similar to the fall protection anchor 100 of FIGS. 1-4. For economy of disclosure, description of similar elements is omitted. The fall protection anchor 600 differs from the fall protection anchor 100 in that the fall protection anchor 600 uses an angled cam member 620 instead of a cam lobe 114 to attach to an I-beam or other planar member in the slot. The angled cam member 620 includes an angled surface that corresponds to an angled surface of an angled surface cavity 608 in the housing of the fall protection anchor 600. As the angled cam member 620 slides down the angled surface cavity 608, the angled cam member 620 moves further into the slot and increases gripping force on any I-beam or planar member in the slot. The angled cam member 620 may be biased to slide down the angled surface cavity 608.

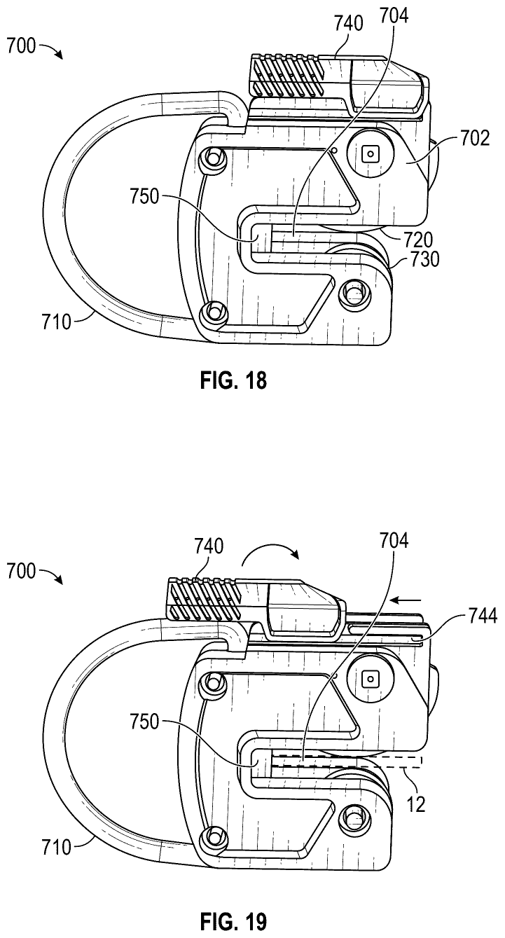

FIGS. 18-23 are views of a fall protection anchor 700 with a pre-load mechanism in accordance with an example embodiment of the disclosed concept. The fall protection anchor 700 includes a body 702 defining a slot 704 structured to receive a flange 12 of an I-beam or other planar member. The fall protection anchor 700 includes a first cam lobe 720 structured to rotate to move into the slot 704 into a gripping position to grip the flange 12 between the first cam lobe 720 and a surface opposite the first cam lobe 720 similar to the fall protection anchor 100. In some example embodiments, a second cam lobe 730 may be provided such that the flange 12 is gripped between the first cam lobe 720 and the second cam lobe 730.

The fall protection anchor 700 includes a pre-load mechanism and a trigger mechanism 750. The pre-load mechanism is operable to move the first cam lobe 720 out of the slot 704 and the trigger mechanism 750 is structured to retain it in a pre-mount position away from the gripping position. The trigger mechanism 750 is also structured to release the first cam lobe 720 from the pre-mount position in response to the flange 12 or other planar member interacting with the trigger mechanism 750. The trigger mechanism 750 is structured such that the flange 12 or other planar member will interact with the trigger mechanism 750 and cause release of the first cam lobe 720 from the pre-mount position only when the flange 12 or other planar member is fully seated within the slot 704. Once the trigger mechanism 750 releases the first cam lobe 720, the first cam lobe 720 will rotate and move into the slot 704 into a gripping position where it grips the flange 12 or other planar member between the first cam lobe 720 and a surface opposite the first cam lobe 720. Operation of the pre-load mechanism and the trigger mechanism 750 will be described with respect to FIGS. 18-23.

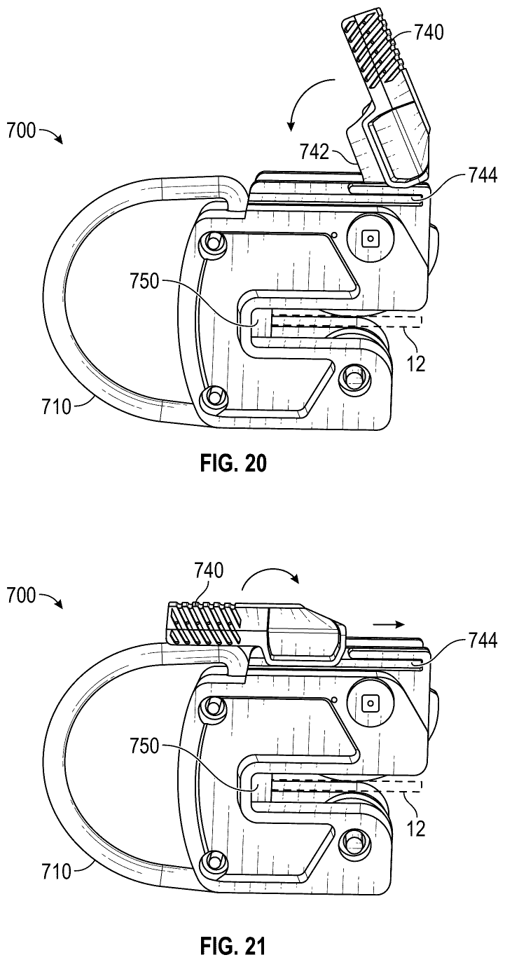

FIG. 18 is a side view of the fall protection anchor 700 in a resting position. The pre-load mechanism includes a lever 742 (shown in FIG. 20) with a slidable extension 740. The slidable extension 740 includes a biasing member (e.g., without limitation, one or more springs) structured to bias the slidable extension 740 toward the lever 742. The slidable extension 740 is structured such that a user interaction can overcome the bias of the biasing member and slide the slidable extension 740 away from the lever 742. In the resting position shown in FIG. 18, the slidable extension 740 is slid fully towards the lever 742 and is seated in a groove 744 (shown in FIG. 19) in the housing 702. When seated in the groove 744, the slidable extension 740 and the lever 742 cannot be rotated.

The lever 742 is rotatably coupled to the housing 702 and may share a common axis of rotation with the first cam lobe 720. The slidable extension 740 is coupled to the lever 742 and is structured to rotate in conjunction with the lever 742. That is, the slidable extension 740 is operable as an extension of the lever 742. The lever 742 is structured such that rotation of the lever 742 upward causes rotation of the first cam lobe 730 away from the gripping position. From the resting position shown in FIG. 18, the slidable extension 740 is slid away from the lever 742 and out of the groove 744 to a prepped position shown in FIG. 19. In the prepped position, the slidable extension 740 and lever 742 may be rotated upward. From the prepped position, the slidable extension 740 and lever 742 are rotated upward by a user and then the slidable extension 740 is release. When the slidable extension 740, the biasing member moves the slidable extension 740 back towards the lever 742 such that the slidable extension 740 rests above the groove 744 in a pre-mount position shown in FIG. 20. When the slidable extension 740 and lever 742 are rotated upward, the first cam lobe 720 rotates away from the gripping position and is caught by the trigger mechanism to be retained away from the gripping position.

When in the pre-mount position, the fall protection anchor 700 is considered to be preloaded. For example, a biasing member biases the first cam lobe 720 toward the gripping position, but the trigger mechanism 750 catches the first cam lobe 720 against this bias and retains the first cam lobe 720 away from the gripping position. Once the trigger mechanism 750 releases the first cam lobe 720, the bias of the biasing member snaps the first cam lobe 720 to the gripping position providing additional initial gripping force and positive indication that the first cam lobe 720 has gripped the flange 12 or other planar member. From the pre-mount position shown in FIG. 20, to release the trigger mechanism 150, the flange 12 or other planar member is fully inserted into the slot 704 such that it interacts with the trigger mechanism 150. When the flange 12 or other planar member interacts with the trigger mechanism 150, the trigger mechanism releases the first cam lobe 720 such that the bias of the biasing member snaps the first cam lobe 720 to the gripping position where the first cam lobe 720 presses against the flange 12 or other planar member to grip it between the first cam lobe 720 and the surface opposite the first cam lobe 720.

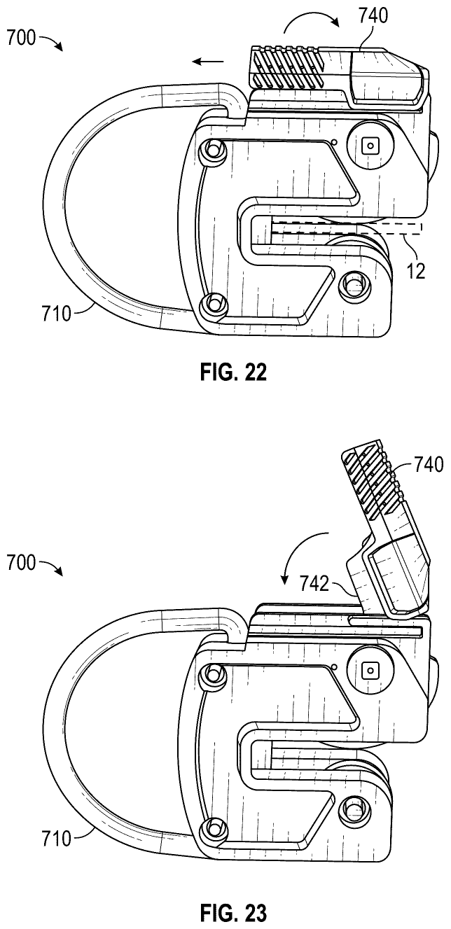

After the flange 12 or other planar member has been fully inserted into the slot 704 such that the trigger mechanism 750 releases, the user then slides the slidable extension 740 away from the lever 742 and rotates the slidable extension 740 and lever 742 downward to a mounting position as shown in FIG. 21. The user then releases the slidable extension 740 and the biasing member of the slidable extension 740 automatically slides the slidable extension 740 toward the lever 742 and into the groove 744 to the fully mounted position shown in FIG. 22. In the fully mounted position, the fall protection anchor 700 will not release its grip on the flange 12 or other planar member without two actions by the user. In an example embodiment, to release the fall protection anchor's 700 grip on the flange 12 or other planar member, the user must perform a first action of sliding the slidable extension 740 away from the lever 742 and out of the groove 744, and a second action of the rotating the lever slidable extension 740 and lever 742 upward. The upward rotation of the slidable extension 740 and lever 742 rotates the first cam lobe 720 away from the gripping position and returns the fall protection anchor 700 to a pre-mount position shown in FIG. 23. In the pre-mount position, the flange 12 or other planar member may be removed from the slot 704 as the first cam lobe 720 is away from the gripping position and is not pressing against the flange 12 or other planar member. That is, the components of the preload mechanism such as the slidable extension 740 and lever 742 are also operable as a release mechanism. In the pre-mount position shown in FIG. 23, the fall protection anchor 700 is reset and ready for use to grip the flange 12 or other planar member.

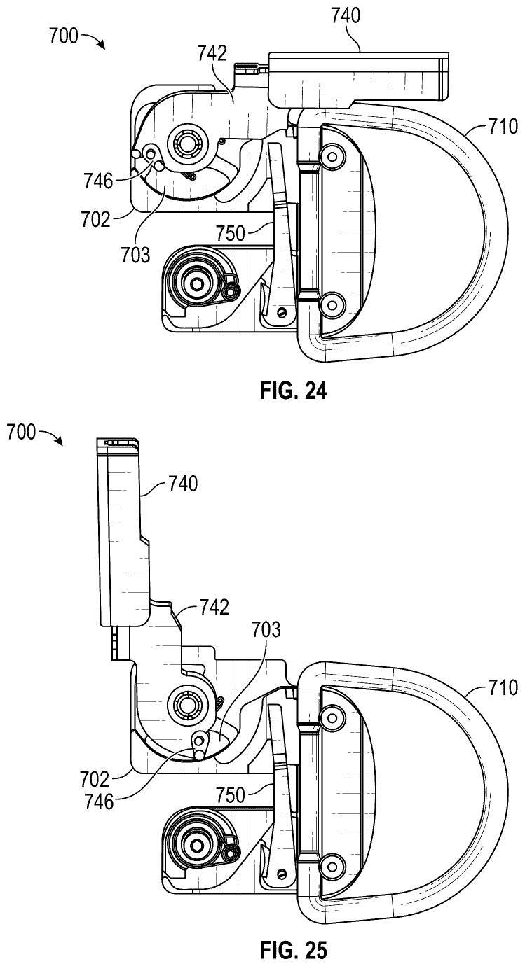

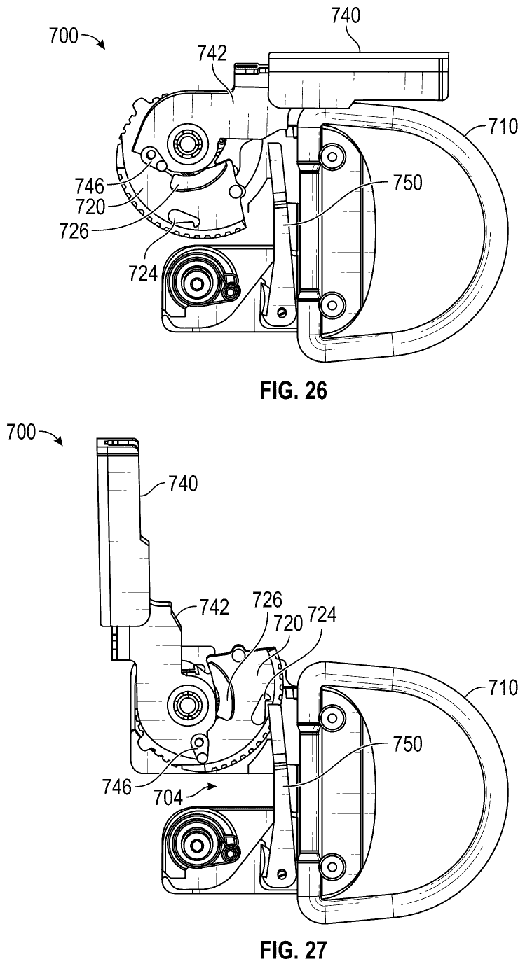

FIGS. 24-27 are side views of the fall protection anchor 700 with components hidden to illustrate internal operations of the pre-load and trigger mechanisms 150. In FIGS. 24 and 25, an outer part of the housing 702 and the first cam lobe 720 are hidden. In FIGS. 26 and 27, the outer part of the housing 702 is hidden, but the first cam lobe 720 is shown. A toggle 746 is rotatably coupled to the lever 742. The housing 702 includes a recess 703 structured to interact with the toggle 746. More specifically, the recess 703 is structured to drive the location of the toggle 746 with respect to the lever 742 depending on the position of the lever 742. As shown in FIG. 24, the lever 742 is rotated downward and the recess drives the toggle 746 to a forward rotated position. When the lever 742 is rotated upward, the recess 703 drives the toggle 746 to a rearward rotated position as is shown in FIG. 25. The toggle 746 is structured to interact with and move the first cam lobe 720 when the toggle 746 is in the forward rotated position. When the toggle 746 is in the rearward rotated position, the toggle 746 is moved away from the first cam lobe 720 allowing the first cam lobe 720 to rotate independently of the lever 742.

The first cam lobe 720 includes a protrusion 726, as shown in FIGS. 26 and 27, that extends outward from the first cam lobe 720 and is structured to interact with the toggle 746. That is, as the lever 742 is rotates upward, the toggle 746 in the forward rotated position abuts against and presses the protrusion 726 to rotate the first cam lobe 720 as the lever 742 is rotated upward. As the lever 742 continues to rotate upward, the recess 703 will drive the toggle 746 to rotate to the rearward rotated position. When the toggle 746 rotates to the rearward rotated position, it no longer abuts against the protrusion 726 and the first cam lobe 720 is then able to rotate independently of the lever 742. As shown in FIG. 27, the toggle 746 is in the rearward rotated position such that the first cam lobe 720 can rotate independent of the lever 742.

The trigger mechanism 750 includes a bar rotatably coupled to the housing 702. The bar is disposed at an inner end of the slot 704 such that the flange 12 or other planar member must be fully inserted into the slot 704 to interact with the bar. A catch 724 is disposed on a side of the first cam lobe 720. The catch 724 is structured to catch on bar of the trigger mechanism 750 when the first cam lobe 720 is rotated away from the gripping position and the fall protection anchor 700 is preloaded. The interaction between the catch 724 and the bar of the trigger mechanism 750 retains the first cam lobe 720 away from the gripping position and preloaded until the trigger mechanism 750 is released. For example, FIG. 27 shows the first cam lobe 720 retained away from the gripping position and preloaded by the interaction between the catch 724 and the bar of the trigger mechanism 750. When the flange 12 or other planar member is fully inserted into the slot 704, the flange 12 or other planar member presses against the bar of the trigger mechanism 750 and rotates the bar away from the catch 724, thus allowing the catch 724 to release from the bar. When the catch 724 releases from the bar, the first cam lobe 720 is released and is able rotate and move into the slot 704 into a gripping position and grip the flange 12 or other planar member. As the first cam lobe 720 is biased to the gripping position, the first cam lobe 720 will snap to the gripping position which provides additional initial gripping force and positive feedback that flange 12 or other planar member is fully seated in the slot 704 and is gripped by the first cam lobe 720.

The fall protection anchor 700 includes an attachment ring 710 suitable as an attachment point for a fall protection lanyard (e.g., without limitation, a snap hook or a similar device). In some example embodiments, the attachment ring 710 is rotatably coupled to the housing 702. High forces can be applied to the attachment ring 710 in the event of a fall. When such forces are applied perpendicular to the slot 704 or in the direction of the slot 704, if the attachment ring 710 were not rotatably attached to the housing 702, the forces could cause the fall protection anchor 700 to rotate about the gripping point of the first cam lobe 720. Such rotation could compromise the fall protection anchor's 700 grip on the flange 12 or other planar member. With the rotatably coupled attachment ring 710, forces applied to the attachment ring 710 perpendicular to the slot 704 impart lower rotational forces at the gripping point and reduce the chances of the fall protection anchor 700 rotating about the gripping point. Additionally, forces applied to the attachment ring 710 in the direction of the slot 704 will pull the fall protection anchor 700 against the flange 12 or other planar member and enhance gripping. While the attachment ring 710 in the present example embodiment is rotatable, it will be appreciated that in some example embodiments the fall protection anchor 700 may employ a fixed attachment ring, such as for example and without limitation, an attachment ring such as the attachment ring 110 shown in FIG. 1 or other similar fixed attachment rings.

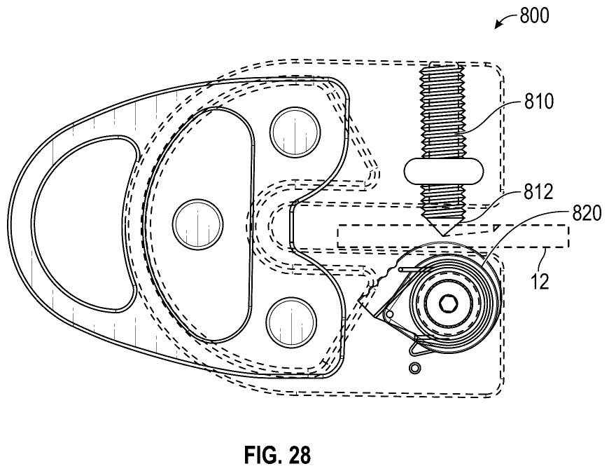

FIG. 28 is a side view of a fall protection anchor 800 in accordance with an example embodiment of the disclosed concept. The fall protection anchor 800 includes a cam lobe 820 structured to grip a flange 12 or other planar member in a manner similar to other embodiments described herein. However, the fall protection anchor 800 includes a translating member 810 disposed opposite of the cam lobe 820. The translating member 810 may include a tapered end 812. In some example embodiments, the translating member 810 may be, for example and without limitation, a set screw. The flange 12 or other planar member may include paint or a coating that lacks strength or consistency that can make gripping more difficult. When the cam lobe 820 grips the flange 12 or other planar member between the cam lobe 820 and the translating member 810, the translating member 810 penetrates the paint or coating of the flange 12 or other planar member and directly contacts the underlying material (e.g., without limitation, steel or aluminum) which typically has more strength and consistency than the paint or coating. Thus, even when paint or a coating on the flange 12 or other planar member could potentially compromise gripping, the translating member 810 penetrating the paint or coating and directly contacting the underlying material ensures a strong grip on the flange 12 or other planar member.

The translating member 810 may be advanced or retracted from the slot. In some example embodiments, the translating member 810 may be a set screw that is advanced or retracted from the slot by rotating the translating member 810. The ability to advance or retract the translating member 810 provides for a degree of adjustability such that different thicknesses of the flange 12 or other planar member can be accommodated. When initially attaching the fall protection anchor 800 to the flange 12 or other planar member, the translating member 810 may be advanced into the slot against the flange 12 or other planar member so as to grip the flange 12 or other planar member between the translating member 810 and the cam lobe 820. In some example embodiments, when initially attaching the fall protection anchor 800 to the flange 12 or other planar member, the translating member 810 may be advanced into the slot such that it penetrates a coating on the flange 12 or other planar member and contacts the underlying material. After the fall protection anchor 800 is initially attached to the flange 12 or other planar member, in the event of a fall or other attempt to pull the flange 12 or planar member out of the slot, the cam lobe 820 will rotate in response to such event and increase a force pressing the flange 12 or other planar member against the translating member 810. The increased force will increase the gripping force on the flange 12 or other planar member, and in some instances will cause the translating member 810 to further penetrate into the flange 12 or other planar member.

While the example embodiment in FIG. 28 illustrates the translating member 810 as a set screw, it will be appreciated that the disclosed concept is not limited thereto. Various alternatives capable of penetrating a coating on the flange 12 or other planar member may be employed. For example and without limitation, the translating member 810 may be an elongated member coupled to a mechanism to advance or retract the translating member 810. In some example embodiments, a cam may be associated with the translating member 810 and operation of the cam may drive the translating member 810 to advance or retract the translating member 810 with sufficient mechanical advantage to penetrate paint or a coating on the flange 12 or other planar member. As another non-limiting example, a linkage assembly may be associated with the translating member 810 and operation of the linkage assembly may advance or retract the translating member 810 with sufficient mechanical advantage to penetrate paint or a coating on the flange 12 or other planar member. It will be appreciated that the translating member 810 is structured to advance into the slot to contact the flange 12 or other planar member and penetrate paint or a coating of the flange 12 or other planar member to contact the underlying material. It will be appreciated that any suitable mechanism for advancing or retracting the translating member 810 may be employed without departing from the scope of the disclosed concept.

While paint or a coating on the flange 12 or other planar member may make gripping more difficult, it will be appreciated that fall protection anchors described with respect to any embodiment herein that do not penetrate the paint or coating may still be employed in association with a flange 12 or other planar member that is painted or coated. In some cases, the fall protection anchor may establish an adequate gripping force with the paint or coating in place. In instances where the paint or coating may substantially compromise the gripping force, before attaching the fall protection anchor to the flange 12 or other planar member, the paint or coating may be scraped away in areas where the fall protection anchor will grip the flange 12 or other planar member.

In accordance with some example embodiments of the disclosed concept, a fall protection anchor includes a housing including a slot structured to receive a planar member, a cam member coupled to the housing and structured to move into the slot into a gripping position to grip the planar member between the cam member and a surface opposite the cam member, a bias member coupled to the cam member and structured to bias the cam member toward the gripping position, and a release mechanism coupled to the cam member and operable to move the cam member away from the gripping position. The embodiments described herein provide some examples of a housing, cam member, bias member, and release mechanism, but the disclosed concept is not limited thereto and any suitable housing, cam member, bias member, and release mechanism may be employed without departing from the disclosed concept.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A fall protection anchor comprising:
a housing including a slot structured to receive a planar member;
a first cam lobe coupled to the housing and having a first cam lobe surface, wherein rotation of the first cam lobe in a first direction causes the first cam lobe surface to extend further into the slot; and
a first cam lobe spring coupled to the first cam lobe and structured to bias the first cam lobe in the first direction.

2. The fall protection anchor of claim 1, further comprising:
a second cam lobe coupled to the housing and having a second cam lobe surface, wherein rotation of the second cam lobe in a second direction causes the second cam lobe surface to extend further into the slot, and wherein the second cam lobe is coupled to the housing on an opposite side of the slot as the first cam lobe.

3. The fall protection anchor of claim 2, further comprising:
a second cam lobe spring coupled to the second cam lobe and structured to bias the second cam lobe in a direction opposite of the second direction.

4. The fall protection anchor of claim 3, wherein a number of teeth are formed on the second cam lobe surface.

5. The fall protection anchor of claim 1, further comprising:
a retraction mechanism coupled to the first cam lobe and operable to rotate the first cam lobe in a direction opposite the first direction.

6. The fall protection anchor of claim 1, further comprising:
an attachment ring coupled to the housing, the attachment ring including an attachment ring opening.

7. The fall protection anchor of claim 6, wherein the attachment ring is rotatably coupled to the housing.

8. The fall protection anchor of claim 1, wherein the first cam lobe includes a first cam lobe axis, and wherein a distance between the first cam lobe axis and the first cam lobe surface increases along a length of the first cam lobe surface.

9. The fall protection anchor of claim 1, wherein a number of teeth are formed on the first cam lobe surface.

10. The fall protection anchor of claim 1 wherein the first cam lobe is structured to frictionally engage the planar member in the slot and rotate in the first direction in response to attempting to pull the planar member out of the slot.

11. The fall protection anchor of claim 1, further comprising:
a preload mechanism operable to rotate the first cam lobe in a direction opposite the first direction and cause the first cam lobe surface to retract from the slot; and
a trigger mechanism structured to retain the first cam lobe in a position where the first cam lobe surface is retracted from the slot, and wherein the trigger mechanism is structured to release the first cam lobe and allow the first cam lobe spring to rotate the first cam lobe in the first direction in response to the planar member being received in the slot.

12. The fall protection anchor of claim 11, wherein the preload mechanism includes a lever rotatably coupled to the housing, and wherein the lever is structured to cause rotation of the first cam lobe in the direction opposite the first direction in response to rotation of the lever.

13. The fall protection anchor of claim 12, wherein the preload mechanism includes a slidable extension slidably coupled to the lever, wherein the slidable extension is biased toward the lever, wherein the housing includes a groove structured to interact with the slidable extension, wherein the slidable extension is structured to slide between a first position in which the slidable extension interacts with the groove and prevents rotation of the lever and a second position in which the slidable extension does not interact with the groove and allows rotation of the lever.

14. The fall protection anchor of claim 12, wherein the preload mechanism is structured to require a first action and a second action to cause the first cam lobe surface to retract from the slot, and wherein the first action is sliding the slidable extension to the second position and the second action is rotating the lever.

15. The fall protection anchor of claim 11, wherein the trigger mechanism includes a bar extending through the slot, wherein the first cam lobe includes a catch structured to interact with the bar to retain the first cam lobe in the position where the first cam lobe is retracted from the slot, wherein the bar is structured to rotate and separate from the catch to release the first cam lobe in response to the planar member being inserted into the slot and interacting with the bar.

16. The fall protection anchor of claim 1, further comprising:
a translating member structured to extend into the slot on an opposite side of the slot as the first cam lobe.

17. A fall protection anchor comprising:
a housing including a slot structured to receive a planar member;
a cam member coupled to the housing and structured to move into the slot into a gripping position to grip the planar member between the cam member and a surface opposite the cam member;
a bias member coupled to the cam member and structured to bias the cam member toward the gripping position; and
a release mechanism coupled to the cam member and operable to move the cam member away from the gripping position.

18. The fall protection anchor of claim 17, further comprising:
an attachment mechanism coupled to the housing, the attachment mechanism including an opening.

19. The fall protection anchor of claim 17, wherein the cam member is structured to sustain grip on the planar member when a force of at least 1800 lbs is applied to the fall protection anchor.

20. The fall protection anchor of claim 17, wherein the release mechanism requires at least two actions to move the cam member away from the gripping position.

21. The fall protection anchor of claim 17, wherein the cam member is structured to provide an increasing gripping force on the planar member in response to a force pulling the gripping member in a direction out of the slot.

22. The fall protection anchor of claim 21, wherein the cam member is structured to produce a gripping force on the planar member that is at least four times the force pulling the gripping member in the direction out of the slot.

23. The fall protection anchor of claim 17, further comprising:
a translating member structured to extend into the slot on an opposite side of the slot as the cam member.

24. A fall protection anchor comprising:
a housing including a slot structured to receive a planar member;
a cam member coupled to the housing and structured to move into the slot into a gripping position to grip the planar member between the cam member and a surface opposite the cam member;
a bias member coupled to the cam member and structured to bias the cam member toward the gripping position;
a preload mechanism operable to move the cam member to a position away from the gripping position; and
a trigger mechanism structured to retain the cam member in the position away from the gripping position, and wherein the trigger mechanism is structured to release the cam member and allow the bias member to rotate the cam member to the gripping position in response to the planar member being received in the slot.

25. The fall protection anchor of claim 24, further comprising:
a translating member structured to extend into the slot on an opposite side of the slot as the cam member.
